(19) United States
(12) Patent Application Publication
(10) Pub. No.: US 2026/0025464 A1
(43) Pub. Date: Jan. 22, 2026

(54) AUTOMATIC AVAILABILITY PREDICTION FOR A SUBJECT MATTER EXPERT

(71) Applicant: NICE LTD., Ra'anana (IL)

(72) Inventors: Susmith ROY, Cachar, Assam (IN); Basavraj GHULI, Pune (IN)

(21) Appl. No.: 18/775,059

(22) Filed: Jul. 17, 2024

(51) Int. Cl. H04M 3/523; G06Q 10/1093

(52) U.S. Cl. CPC H04M 3/5233; G06Q 10/1093; H04M 3/5238

(57) ABSTRACT

A system automatically identifies wait times for a subject matter expert (SME). The system includes a cloud server in communication with an agent computer, an SME computer, and a database for storing presence data associated with the SME computer. Over a first period of time, the processor receives the presence data associated with the SME computer; stores the presence data in the database; and trains a custom machine learning network. The processor receives an input from the agent computer requesting contact with the SME computer, and solicits a status from the SME computer. If the status is not “Available”, the processor, using the trained custom machine learning network, predicts a wait time after which the status will be “Available” and reports the predicted wait time to the agent computer. If the status is “Available”, the system establishes a communication link between the agent computer and the SME computer.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to devices, systems, and methods for automatically predicting the availability of a subject matter expert. This presence prediction system has particular but not exclusive utility for contact centers and “contact center as a service” (CCaaS) providers.

### BACKGROUND

In a call center or contact center, agents converse with patrons to address various issues. At times, resolution of the issues may require consulting with a subject matter expert (SME) from a business unit. Subject matter experts may for example be more familiar than agents with specific subjects such as banking, checking, credit cards, etc. Often, the agent searches for an SME using a directory search for individuals with a particular skill set. Today's systems provide, along with the SME details, a presence status for each identified SME, indicating whether that SME is available or unavailable for consultation.

Contact centers traditionality don't track back office or SME state and availability data. However, as customer requests that are handled by human agents are becoming more complex, the need to provide SME consulting services from nontraditional agents is becoming a prerequisite function of a customer experience center. The need to inform the agent of the availability of back-office SME services is critical to provide rapid and accurate service to the patron. Time wasted by the agent hunting for an SME, or using other tools to communicate with SME's, is an unnecessary cost and can delay providing an answer to a valuable customer or one with contractual timing for response requirements. Accordingly, a need exists for improved SME presence tracking tools which address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a presence prediction system having particular, but not exclusive, utility for call centers, contact centers and “contact center as a service” (CCaaS) providers. A presence prediction system receives feeds from a presence aggregator, which receives status updates for SMEs (e.g., all status updates for all SMEs). The presence prediction system then runs an algorithm on historic data and calculates the average time required by SME to return to ‘available’ state from Busy/In-Call/Unavailable etc. The Presence aggregator also checks the SME's calendar to see meeting schedules/OOO rules for the SME. With this solution in place, when the agent searches for SME directory services, the agent sees not only the SME's presence state, but also their expected time to availability.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically identify wait times for a subject matter expert. The system includes a cloud server having at least one processor and a non-transitory computer readable medium operably coupled thereto, the cloud server being in electronic communication with an agent computing device and a subject matter expert (SME) computing device. The processor may include a presence aggregator module and a presence prediction system, the server being in electronic communication with a database for storing presence data associated with the SME computing device. The computer readable medium may include a plurality of instructions stored in association therewith that are accessible to, and executable by, the processor, to perform operations which may include: over a first period of time, with the presence aggregator module: receiving the presence data associated with the SME computing device; storing the presence data in the database; and with the stored presence data, training a custom machine learning network; receiving an input from the agent computing device requesting contact with the SME computing device; and soliciting a status from the SME computing device. If the status is not “available”, then with the presence prediction system: using the trained custom machine learning network, predicting a wait time after which the status will be available and reporting the predicted wait time to the agent computing device; or if the status is “available”, then establishing a communication link between the agent computing device and the SME computing device and transmitting a query to the SME computing device. Other embodiments of this aspect include corresponding computer systems, apparatus, and computer programs recorded on one or more computer storage devices, each configured to perform the actions of the methods.

Implementations may include one or more of the following features. In some embodiments, the custom machine learning network is a long short-term memory (LSTM) recurrent neural network (RNN). In some embodiments, the operations further may include, with the agent computing device, displaying the predicted time to an agent. In some embodiments, if the status is not “available”, then the status is one of “busy”, “in call”, “unavailable”, “away”, “do not disturb”, or “offline”. In some embodiments, the operations further may include: soliciting a calendar associated with the SME computing device; and based on the calendar, refining the predicted time. In some embodiments, the calendar contains, for each time in the calendar, a calendar status of “available”, “busy”, or “meeting”. In some embodiments, the presence data may include statuses of “available”, “busy”, “in call”, “unavailable”, “away”, “do not disturb”, or “offline”, and one or more times associated therewith. In some embodiments, the system may include a communication link between the agent computing device and a patron computing device. Implementations of the described techniques may include hardware, a method or process, or computer software on a computer-accessible medium.

One general aspect includes a computer-implemented method for automatically identifying wait times for a subject matter expert. The computer-implemented method uses a cloud server having at least one processor and a non-transitory computer readable medium operably coupled thereto, the cloud server being in electronic communication with an agent computing device and a subject matter expert (SME) computing device, the including a presence aggregator module and a presence prediction system, the server being in electronic communication with a database for storing presence data associated with the SME computing device. The computer-implemented method includes, over a first period of time, with the presence aggregator module: receiving the presence data associated with the SME computing device; storing the presence data in the database; and with the stored presence data, training a custom machine learning network. The method also includes receiving an input from the agent computing device requesting contact with the SME computing device; soliciting a status from the SME computing device; if the status is not “available”, then with the presence prediction system: using the trained custom machine learning network, predicting a wait time after which the status will be available and reporting the predicted wait time to the agent computing device; or if the status is “available”, then establishing a communication link between the agent computing device and the SME computing device and transmitting a query to the SME computing device. Other embodiments of this aspect include corresponding computer systems, apparatus, and computer programs recorded on one or more computer storage devices, each configured to perform the actions of the methods.

Implementations may include one or more of the following features. In some embodiments, the custom machine learning network is a long short-term memory (LSTM) recurrent neural network (RNN). In some embodiments, the method may include, with the agent computing device, displaying the predicted time to an agent. In some embodiments, if the status is not “available”, then the status is one of “busy”, “in call”, “unavailable”, “away”, “do not disturb”, or “offline”. In some embodiments, the method may include: soliciting a calendar associated with the SME computing device; and based on the calendar, refining the predicted time. In some embodiments, the calendar contains, for each time in the calendar, a calendar status of “available”, “busy”, or “meeting”. In some embodiments, the presence data may include statuses of “available”, “busy”, “in call”, “unavailable”, “away”, “do not disturb”, or “offline”, and one or more times associated therewith. In some embodiments, the method may include establishing a communication link between the agent computing device and a patron computing device and transmitting a second query to the SME computing device. Implementations of the described techniques may include hardware, a method or process, or computer software on a computer-accessible medium.

One general aspect includes a computer-implemented method over a first period of time: receiving presence data associated with a subject matter expert (SME) via an SME computing device; storing the presence data in a database; and with the stored presence data, training a custom machine learning network. The method also includes receiving an input from an agent, via the agent computing device, requesting contact with the SME computing device; soliciting a status from the SME computing device; if the status is not “available”, then: using the trained custom machine learning network, predicting a wait time after which the status will be “available” and reporting the predicted wait time to the agent via the agent computing device; or if the status is “available”, then establishing a communication link between the agent computing device and the SME computing device and transmitting a query to the SME via the SME computing device. Other embodiments of this aspect include corresponding computer systems, apparatus, and computer programs recorded on one or more computer storage devices, each configured to perform the actions of the methods.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the presence prediction system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of an example presence prediction system, in accordance with at least one embodiment of the present disclosure.

FIG. 2 is a schematic, diagrammatic representation, in block diagram form, of an example presence prediction system, in accordance with at least one embodiment of the present disclosure.

FIG. 3 is a schematic, diagrammatic representation, in flow diagram form, of an example presence aggregator method, in accordance with at least one embodiment of the present disclosure.

FIG. 4 is a schematic, diagrammatic representation, in flow diagram form, of an example presence prediction method, in accordance with at least one embodiment of the present disclosure.

FIG. 5 is a schematic, diagrammatic representation, in flow diagram form, of an example presence prediction method, in accordance with at least one embodiment of the present disclosure.

FIG. 6 is a schematic, diagrammatic representation, in block diagram form, of an example presence prediction system, in accordance with at least one embodiment of the present disclosure.

FIG. 7 is a schematic, diagrammatic representation, in block diagram form, of an example presence prediction system, in accordance with at least one embodiment of the present disclosure.

FIG. 8 is a schematic, diagrammatic representation, in block diagram form, of an example presence prediction system, in accordance with at least one embodiment of the present disclosure.

FIG. 9 is a screen display of an example presence prediction system, in accordance with at least one embodiment of the present disclosure.

FIG. 10 is a screen display of an example presence prediction system, in accordance with at least one embodiment of the present disclosure.

FIG. 11A is a screen display of an example CCaaS system that does not incorporate the presence prediction system, in accordance with aspects of the present disclosure.

FIG. 11B is screen display of an example CCaaS system that incorporate the presence prediction system, in accordance with at least one embodiment of the present disclosure.

FIG. 12 is a schematic diagram of a processor circuit, according to embodiments of the present disclosure.

### DETAILED DESCRIPTION

In accordance with at least one embodiment of the present disclosure, a presence prediction system is provided which predicts the availability of a subject matter expert (SME) based on the SME's past behavior.

Today there is no mechanism to know even tentatively when an SME/Consultant will become ‘available’ after a status of ‘busy’, ‘unavailable’, ‘away’, etc. Whether an SME is Out Of Office (OOO) for a day or in a meeting for an hour, the agent does not even know for how long the SME is unavailable to respond. The agent may keep searching for a particular SME for different cases, assuming that the SME could now be available. Current mechanisms may let the agent know of an Out Of Office message set by the SME, if one exists, but do not provide information regarding meetings, breaks, other contacts, etc., and their expected durations or ending times. Thus, the estimated time to availability (ETA) of the SME is generally not currently known to the agent.

In an example using current technology, Mr. John and a few other users are SMEs in a home lending department. Agent A receives an inbound call from a patron, who needs details on home loan products. Agent A is therefore in a situation where he/she must consult with SMEs from the home lending department in a timely manner. Agent A can either search for Mr. John or for the group to which Mr. John belongs. In both the cases, he/she may find that all the SMEs are already busy consulting. In this situation, Agent A does not know who is likely to be available first. The present disclosure provides devices, systems, and methods for determining and reporting SME ETAs to an agent.

In an example incorporating the presence prediction system of the present disclosure, Mr. John is in a meeting for the next 1 hour. During this hour, multiple agents might try to contact Mr. John for consultation, but do not do so, because they know John's future availability. If Agent A can see that Mr. John is not available for next hour along with Mr. John's presence status, the agent would avoid spending time reaching out to John, and would contact a different SME instead, or inform the patron of an expected delay before further consultation will be possible. Agent A might also leave a message, e.g., via one or more suitable channels such as those discussed below requesting the SME to reply once available.

A presence prediction system will get input from a presence aggregator, which will receive all the status updates for SMEs. The presence prediction system then will run an algorithm on historic data and calculate the average time required by SME to return to ‘available’ state from Busy/In-Call/Unavailable etc. The Presence aggregator will also check the SME's calendar to see meeting schedules/OOO rules for the SME. With this solution in place, when the agent searches for SME directory services, the agent would see not only the SME's presence state, but also their expected time to availability, and optionally one or more alternative SMEs during that period of unavailability of a preferred SME.

This is a novel approach that requires new metrics, methods, and calculations to collect the data and then present meaningful information to the agent. The technology is particularly useful for “contact center as a service” (CCaaS) and “unified communications as a service” (UCaaS) providers to make their presence engines able to predict a specific user's future state. Existing presence solutions have been on the market for 20+ years, but the way presence is handled has evolved over time. For example, in the UCaaS/Unified Communication domain, a couple of seconds or minutes may not matter a lot. However, in CCaaS environments, every second of the agent's time is typically accounted for. Agents' performance is tracked, and efforts are made to enhance it, as better performance of agents often results in saving additional dollars and the need for fewer agents to be available given an expected workload during a period of time. The present disclosure helps to avoid repeated, inefficient actions by agents in searching for an available SME.

In an example, a status aggregator or presence aggregator aggregates all the state changes for the SMEs within an organization. The organization may be a contact center, a third-party provider of SMEs, an SME network, etc. The state generators may for example be telepresence systems such as Microsoft Teams, Ring Central, Cisco WebEx, Zoom etc. The aggregator service stores all the historic data on timeseries. A learning module keep learning various components for each actor like average time spent by an actor on call, regular meeting cadence, daywise breaks taken for coffee, lunch etc. The learning module will thus have a rich set of information for a user. It also learns patterns based on historic data. Based on this learning, the service can make predictions about an SME's future availability behavior.

In an example, if the SME's state is ‘In-Call’, the learning module or presence prediction system will check the average time taken by a user in a call or even that specific SME's average time. Based on that, the learning module or presence prediction system can predict the ETA for the current call. A writer module will keep averaging the time and keep the learning module updated. This method will keep running in the background and the learning module keep getting more mature with every state change and/or additional relevant data input, and thus increases in accuracy with respect to future predictions.

The present disclosure aids substantially in maximizing the efficiency of a contact center agent's time, by reducing the amount of time required to connect with an available subject matter expert. Advantageously, this is also typically more efficient for an agent's customer or patron, who may be provided an estimated wait time instead of waiting on hold while an agent seeks SME availability, particularly if the expected waiting time is over a preset threshold. Implemented on a cloud server in communication with an agent computing device and an SME computing device, the presence prediction system disclosed herein provides practical improvements in the connection between the agent computing device and the SME computing device, by reducing the downtime of that connection. This improved method transforms a manual process of hunting and waiting for an available SME into a simple process of knowing approximately when each unavailable SME will next be available. This occurs without the normally routine need to search for multiple SMEs until one becomes available. This unconventional approach improves the functioning of the agent computing device, by reducing the downtime spent searching or waiting for an SME.

The presence prediction system may be implemented as a process at least partly viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain outputs of the presence prediction system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the presence prediction system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

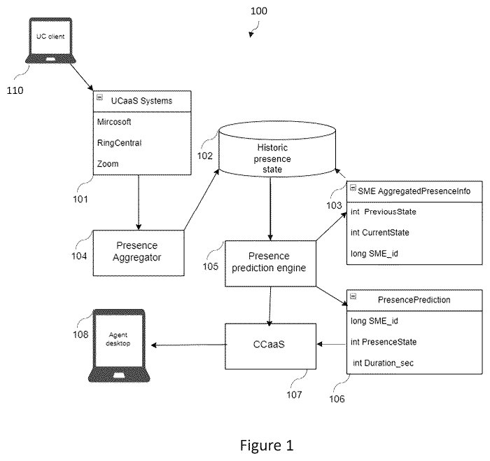

FIG. 1 is a schematic, diagrammatic representation, in block diagram form, of an example presence prediction system 100, in accordance with at least one embodiment of the present disclosure. In the example shown in FIG. 1, a unified communications (UC) client computing device or SME computing device 110 is in contact with one or more UCaaS systems 101. In an example, the UC client computing device 110 is a laptop operated by a subject matter expert, and the UCaaS system 101 is at least one of Microsoft Teams, Ring Central, Cisco WebEx, or Zoom. The availability status of the UC client computing device 110 (e.g., the availability of the SME operating the client computing device) is tracked by a presence aggregator 104, which logs every time the UC client computing device or SME computing device 110 changes status. Examples of UC client computing device status include, but are not limited to, “available”, “busy”, “in call”, “unavailable”, “away”, “do not disturb”, “offline”, “meeting”, or “out of office”. These status changes, along with their associated times, are stored in a historic presence state database 102, and read by a presence prediction engine 105, which determines aggregate presence information 103 for the UC client computing device or SME computing device 110 (e.g., presence of the SME operating the computing device 110). The presence prediction engine 105 also determines a presence prediction 106, detailing when the UC client computing device or SME computing device is next expected to be available. This information is passed through the contact center's CCaSS system 107 and displayed on the agent computing device 108 (e.g., a computing device operated by an agent of the contact center).

In an example, the UCaaS system 101 sends an event for the presence of a subscribed user (e.g., an SME). This presence information is stored in the time-series based data store 103 by the presence aggregator 104. The presence prediction engine 105 runs methods explained below, to predict the presence state of the user (e.g., the SME). The information is stored in the data store 103 with various attributes like previous state, current state, SME identity etc. The representation 106 of the presence prediction data set for the user (e.g., the SME) can predict the presence of the SME and the duration in which the presence state can change. CCaaS systems 107 derive the SME state and the estimated change in presence from the presence prediction engine 105 and feed it to the agent computing device 108 whenever the agent searches for a backend user (e.g., an SME) using an address book or roster.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the step, and may thus represent an improvement in the user interface over existing art by providing information not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

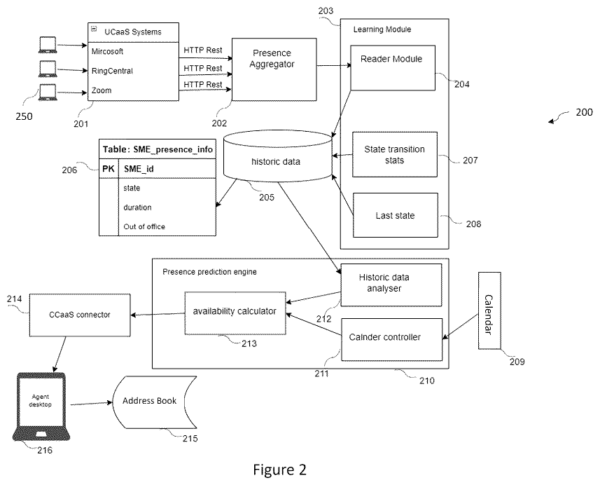

FIG. 2 is a schematic, diagrammatic representation, in block diagram form, of an example presence prediction system 200, in accordance with at least one embodiment of the present disclosure. In the example shown in FIG. 2, multiple SME computing devices 250 are in contact with UCaaS systems 201 (e.g., Microsoft Teams, RingCentral, Cisco WebEx, or Zoom), and their presence statuses are received by the presence aggregator 202, which passes information to a reader module 204 within a learning module 203 and saved in the historic data database 205. The data includes state transition statistics 207, the last state 208 (e.g., the most recent state) of each SME computing device, and SME presence info including states, durations, and out of office flags. The historic data database 205 is read by a historic data analyzer 212 of a presence prediction engine 210. Outputs of the historic data analyzer 212 are passed to an availability calculator 213, along with the outputs of a calendar controller 211 reading a calendar 209. Outputs of the availability calculator 213 are passed to a CCaaS connector 214, which passes them to the address book 215 of the agent computing device 216.

In an example, the SME computing devices 250 represent the various UC vendors in the market who support enterprise communication over various channels like email, voice, video, chat, simple message system (SMS), instant message/direct message (IM/DM), etc. Whenever an SME becomes busy on a voice or video channel, the event is generated for an already-created subscription. These events could reach to the subscriber over webhooks, websocket or long polling. The presence aggregator 202 is one such subscriber. The learning module 203 is the module which reads and learns, based on the periodic events received from the SME computing devices 250 for a set of users (e.g., SMEs) whose presence is of interest. The reader module 204 reads the SME state and stores it in a time-series database 205 with different attributes in consideration, like SME_id, presence state, duration in specific state, etc. The learning module 203 represents the data set 206 to a state transition stats module 207 which continuously analyzes the data received by the reader module 204 from the UCaaS systems 201, and generates various stats such as mean time, average time, max time of the SME in a specific state. The last state 208 may for example be a transient data store, such as cache memory, which remembers the last state of the SME. The calendar 209 is an external entity which has the record of all the events scheduled for a user (e.g., an SME), such as meetings, out of office etc. The presence prediction engine 210 is a collection of historic data analyzer 212, calendar controller 211 and availability calculator 213. The calendar controller 211 reads the information from the backend calendar system for a user's out of office settings, duration of out of office, availability due to meetings and events etc. The historic data analyzer 212 formats the data from the data store 205 and provides it to the availability calculator 213, whose job may for example be to find the find median, min, max and average for any user's presence state, and, based on a configuration set by an administrator, to continuously compute the next availability.

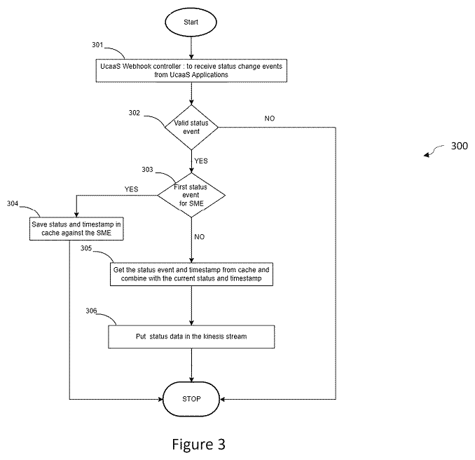

FIG. 3 is a schematic, diagrammatic representation, in flow diagram form, of an example presence aggregator method 300, in accordance with at least one embodiment of the present disclosure. It is understood that the steps of method 300 may be performed in a different order than shown in FIG. 3, additional steps can be provided before, during, and after the steps, and/or some of the steps described can be replaced or eliminated in other embodiments. One or more of steps of the method 300 can be carried by one or more devices and/or systems described herein, such as components of the system 100, system 200, and/or processor circuit 1250.

In step 301, the method 300 includes, with a UCaaS controller (e.g., a Webhook controller), receiving status changes in the UCaaS applications.

In step 302, the method 300 includes determining whether the status received is valid. If no, then the method 300 is complete, as only valid events are passed to the next step, and the rest are discarded. If yes, then execution proceeds to step 303.

In step 303, the method 300 includes determining whether the status received is the very first status change for the SME. If yes, execution proceeds to step 304. If no, execution proceeds to step 305.

In step 304, the method 300 includes saving the status and its associated timestamp in the cache. The method 300 is now complete.

In step 305, the method 300 includes retrieving the previous status and timestamp and status along with the current status and timestamp. Execution then proceeds to step 306.

In step 306, the method 300 includes sending the statuses and timestamps, via a data stream manager such as Kinesis, to the presence prediction engine. The method 300 is now complete.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, in order to avoid a perception of latency on the part of the agent, the SME ETAs may need to be calculated and displayed within less than 1 second from the time a search query is entered.

Before continuing, it should be noted that the examples described above are provided for purposes of illustration, and are not intended to be limiting. Other devices and/or device configurations may be utilized to carry out the operations described herein.

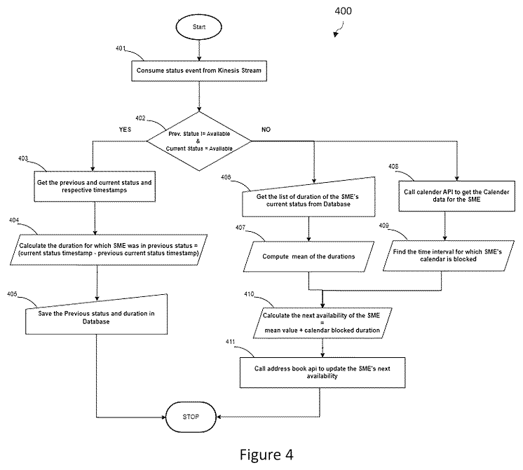

FIG. 4 is a schematic, diagrammatic representation, in flow diagram form, of an example presence prediction method 400, in accordance with at least one embodiment of the present disclosure.

In step 401, the method 400 includes consuming (receiving) the status data sent into the data stream manager in step 306 of FIG. 3.

In step 402, the method 400 includes determining whether the previous status is not “available” and the current status is “available”. If yes, then the control goes into the learning module steps, and execution proceeds to step 403. If no, then the presence prediction module is triggered, and execution proceeds to steps 406 and 408.

The learning module keeps learning various components for each actor like average time spent by an actor on call, regular meeting cadence, day wise breaks taken for coffee, lunch, etc. Generally speaking, the learning module will have a rich set of information for a user. In this module, the previous status denotes any status other than “available” (e.g., “busy”, “offline”, “in call” etc.) and the current status is “available”.

Thus, in step 403, the method 400 includes holding the previous status and its timestamp, current status and its timestamp in memory. Execution then proceeds to step 404.

In step 404, the method 400 includes calculating the status transition duration from the previous status to “available”. For example:

duration=timestamp when SME became “available”−timestamp when SME's status changed into previous status. Execution then proceeds to step 405.

In step 405, the method 400 includes saving the status transition duration and the previous status in the database. The method 400 is now complete.

The presence prediction engine uses the data saved by the learning module to predict the SME's next availability in this module current status represents one of the statuses other than “available”.

Thus, in step 406, the method 400 includes searching the current status of the SME in the database, and fetching the durations associated with that status for that SME. Execution then proceeds to step 407.

In step 407, the method 400 includes computing the mean of the durations from step 406. Execution then proceeds to step 410.

In step 408, the method 400 includes calling the calendar API to get the information about the events scheduled for the current SME, such as meetings, out of office, etc. Execution then proceeds to step 409.

In step 409, the method 400 includes finding the time interval for which the SME's calendar is blocked (e.g., in any status other than “available”). Execution the proceeds to step 410.

In step 410, the method 400 includes calculating the ETA of the SME. For example, ETA=mean status transition duration+calendar blocked duration. Execution then proceeds to step 411.

Is step 411, the method 400 includes calling the address book application program interface (API) to save the SME ETA (e.g., the next availability of the SME) in the address book. The method 400 is now complete.

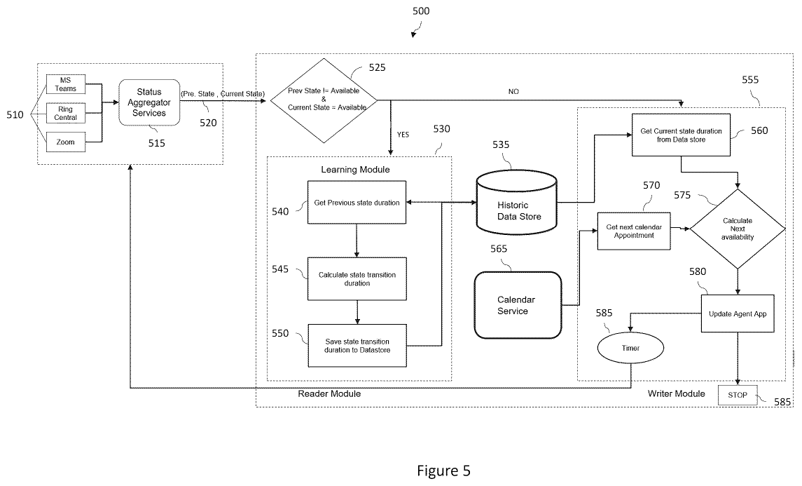

FIG. 5 is a schematic, diagrammatic representation, in flow diagram form, of an example presence prediction method 500, in accordance with at least one embodiment of the present disclosure.

In step 515, a status aggregator service receives current statuses from one or more unified communication applications 510, and passes information 520 (e.g., previous status and current status, with associated time stamps) to step 525.

In step 525, the method 500 includes determining whether the status has switched to “available” from a previous state of something other than “available”. If yes, execution proceeds to step 540 within the learning module or reader module 530. If no, execution proceeds to step 560 within the writer module 555.

In step 540, the method 500 includes retrieving the previous state duration from the historic data store database 535. Execution then proceeds to step 545.

In step 545, the method 500 includes calculating the state transition duration, as described above. Execution then proceeds to step 550.

In step 550, the method 500 includes saving the state transition duration to the historic data store database 535. The method 500 is now complete.

In step 560, the method 500 includes fetch the current state duration from the data store 535. Execution then proceeds to steps 570 and 575.

In step 570, the method 500 includes fetching the next calendar appointment for the current SME from the calendar service 565. Execution then proceeds to step 575.

In step 575, the method 500 includes calculating the next availability for the current SME. Execution then proceeds to step 580.

In step 580, the method 500 includes updating the agent application with the next availability computed in step 575. This information is then used to set a timer 585 which is fed back to the status aggregator 515. The method 500 is now complete.

In an example, the status aggregator 515 is the endpoint which aggregates all the state change for an organization. The state generators can be the same or a different telepresence system as the UCaaS applications. The aggregator service 515 stores all the historic data on timeseries in the data store database 535. The learning module or reader module 530 keeps learning various components for each actor like average time spent by an actor on calls, regular meeting cadence, daywise breaks taken for coffee, lunch etc. Generally speaking, the learning module 530 will have a rich set of information for each user (e.g., each SME). It also stores patterns based on historic data and can thus make predictions about an SME's future behavior.

Thus, if for example the user's state is ‘In-Call’, then the learning module 530 will check the average time taken by user in a call. Based on that, the learning module can predict the estimated duration of the current call. The writer module 555 will keep averaging the time and keep the learning module 530 updated. This method will keep running in the background and the learning module will thus further mature with every state change, to increase its accuracy with respect to the prediction. Depending on the implementation, the learning module may be or include a custom machine learning model such as a Long Short-Term Memory (LSTM) Recurrent Neural Network (RNN).

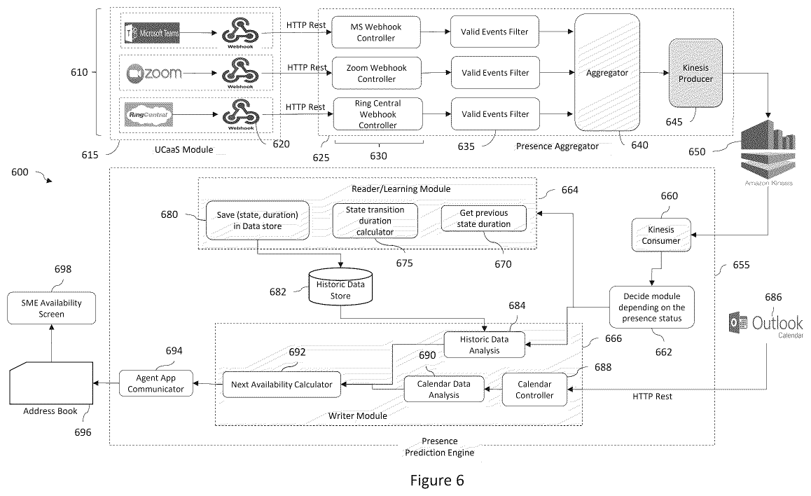

FIG. 6 is a schematic, diagrammatic representation, in block diagram form, of an example presence prediction system 600, in accordance with at least one embodiment of the present disclosure. In the example shown in FIG. 6, a “uniform communications as a service” (UCaaS) module 615 includes UCaaS applications 610 connected by callback functions HTTP push APIs 620 to controllers 630 within the presence aggregator 625. The presence aggregator 625 includes filters 635 that remove invalid state change events, and pass the valid state change events to an aggregator module 640, which passes the aggregated events to a message conveyor producer 645, through the message conveyor 650, to a message conveyor consumer 660 within the presence prediction engine 655.

The message conveyor consumer 660 passes data to a decision module 662, which determines, based on the current presence status, whether to activate the reader module or learning module 664 or the writer module 666. The reader module or learning module 664 includes a fetch step for the previous state duration 670, a state transition calculator 675, and a save module 680 that saves each state and its duration in the historic data store database 682.

Within the writer module 666, a historic data analysis module 684 receives data from the historic data store 682 and passes it to the next availability calculator 692. In parallel, the calendar controller 688 receives data from a calendar 686, and passes it to a calendar data analysis module 690, which also passes data to the next availability calculator 692, which computes the next availability and passes it to an agent application communicator 694, which updates the address book 696 and displays the results on the SME availability screen 698 of the agent application.

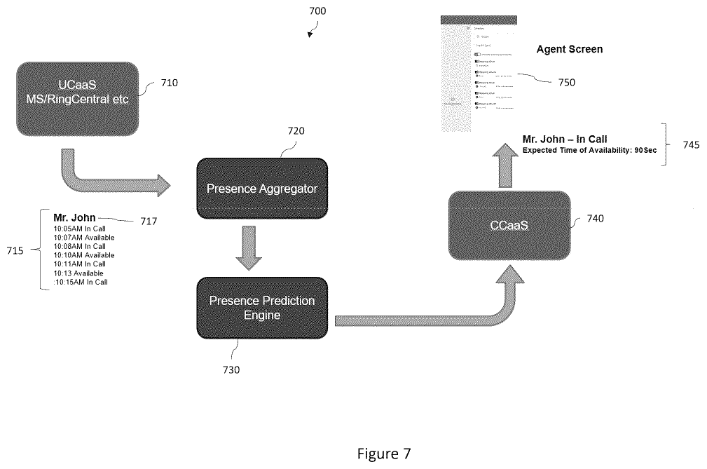

FIG. 7 is a schematic, diagrammatic representation, in block diagram form, of an example presence prediction system 700, in accordance with at least one embodiment of the present disclosure. In the example shown in FIG. 7, the UCaaS module 710 passes availability data 715 for an SME 717 to the presence aggregator 720, which passes aggregated presence data to the presence prediction engine 730, which then passes the next availability 745 to the CCaaS system 740, which then passes it to the agent screen 750 of the agent application running on the agent computing device.

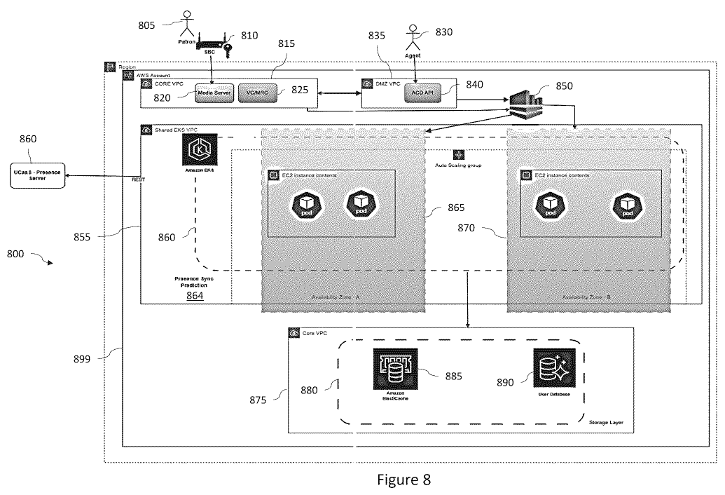

FIG. 8 is a schematic, diagrammatic representation, in block diagram form, of an example presence prediction system 800, in accordance with at least one embodiment of the present disclosure. In the example shown in FIG. 8, a patron 805 is in communication with an agent 830. The patron 805 communicates via a session border controller (SBC) 810, which is in communication with a media server 820, running on a core virtual personal computer (VPC) 815 running on a web services account 899. The core virtual PC 815 also runs a virtual cluster/media resource controller (VC/MRC) or word routing engine application 825 that forms the network boundary for the application.

The agent 830 communicates through a demilitarized zone (DMZ) virtual personal computer (VPC) running an automatic call distributor (ACD) application program interface (API). The core VPC 815 and the DMZ VPC 835 can communicate via a message conveyor or message bus 850 (e.g., Kinesis or Kafka) with availability zones 865, 870 running on an elastic Kubernetes service (EKS) 860, which runs on a shared EKS VPC 855 within the web services account 899. Presence sync prediction 864 occurs on the EKS VPC 855, which communicates with the UCaaS presence server 860.

The EKS service 860 communicates with a second core VPC 875, which executes a storage layer 880, which includes a cache 885 and a user database 890.

In an example, the user database 890 is an Amazon AuroraDB table containing back-office agent details pulled from partner system, UCaaS partners (e.g., via the UCaaS presence server 860) are the domain to which back-office agents may be connected, Presence Sync Prediction 864 is a microservice hosted in AWS managed Kubernetes EKS, and the SBC 810 is the session border controller through which the patron connects to the CCaaS infrastructure for a voice call. The architecture shown in FIG. 8 is exemplary; a person of ordinary skill in the art will appreciate that other architectures may be used instead or in addition, to embody the system and perform the methods described herein.

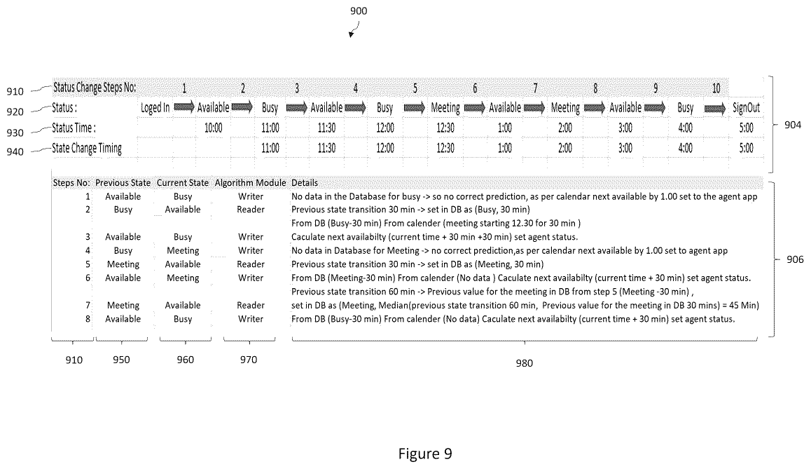

FIG. 9 is a screen display of 900 an example presence prediction system, in accordance with at least one embodiment of the present disclosure. The screen display 900 includes a status table 904 and a detail block 906 for a given SME. The status table 904 includes a status change step count 910, a status line 920 showing the SME's status changes at different times during a shift, a status time line 930 showing the times at which the status changes occurred, and a state change timing line showing predicted times at which state changes occurred. In the example shown in FIG. 9, line 940 is identical to line 930 except for the first state change, for which no prior data exists in the database and thus no accurate prediction can be made.

The detail block 906 contains, for each step 910, a previous state 950, a current state 960, a method 970 (e.g., either “reader module” or “writer module”) for handling the state change, and details 980 describing the status change and how it is handled. The screen display 900 of FIG. 9 is exemplary, and may for example represent a debug screen, development screen, or troubleshooting screen, as such information may not be directly useful to an agent during an ordinary shift.

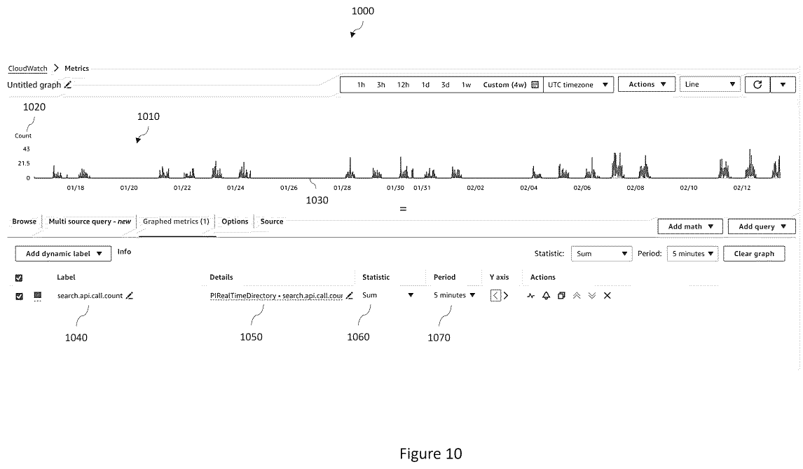

FIG. 10 is a screen display 1000 of an example presence prediction system, in accordance with at least one embodiment of the present disclosure. The screen display 1000 of an example includes a graph 1010 of the number of calls 1020 being handled by subject matter experts over a period of time 1030. As can be seen from the graph 1010, some dates (e.g., weekends and holidays) have no calls, while other dates have clusters of calls at different times of day (e.g., a morning cluster and an afternoon cluster). According to the graph 1010, the number of calls at any given time may be as high as 43, which may for example represent the total number of SMEs in an organization (e.g., 100% of SMEs are engaged in a call). During periods of high call volume, an agent may have a particularly difficult time finding an available SME. The presence prediction system of the present disclosure helps mitigate this difficulty by letting the agent know when each SME is likely to become available, such that even if all SMEs are presently engaged with calls, the agent can tell which SMEs are likely to be available in the next few minutes.

The screen display 1000 also includes a variable selector 1040 that allows a uses to select which variable to graph, as well as a detail block 1050 explaining the graph, a statistic block 1060 showing how the variable is to be handled (e.g., sum, max, min, average, etc.), and a period selector 1070 indicating the time step granularity for the time period 1030. The screen display 1000 of FIG. 10 is exemplary, and may for example represent a debug screen, development screen, or troubleshooting screen, as such information may not be directly useful to an agent during an ordinary shift.

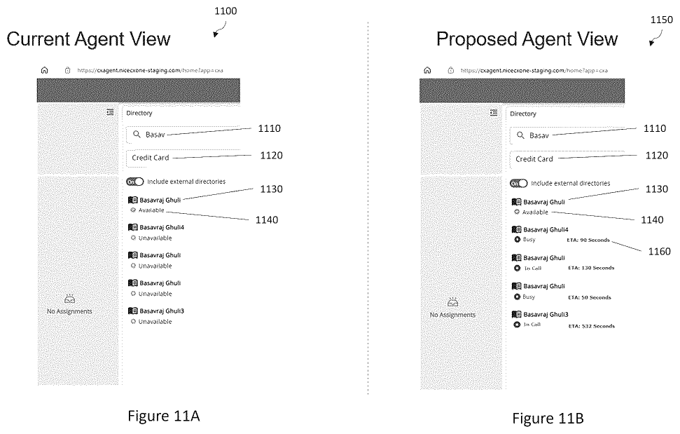

FIG. 11A is a screen display 1100 of an example CCaaS system that does not incorporate the presence prediction system, in accordance with aspects of the present disclosure. The screen display 1100 includes a directory search box 1110, into which the agent can type all or a portion of an SME's name, with which to search the directory, and also a subject matter search box, into which the agent can type part or all of an SME's area of subject matter expertise, with which to search the directory. The screen display 1100 also includes a list of SMEs 1130 and the current status 1140 of each SME. Such status may for example be “Available”, “Busy”, “In Call”, “Unavailable”, “Away”, “Do Not Disturb”, “Offline”, “Meeting”, “Out Of Office”, etc.

Current address books in combination with a presence server are only capable of showing the presence state of users, and not when the user is expected to be available.

FIG. 11B is screen display 1150 of an example CCaaS system that incorporate the presence prediction system, in accordance with at least one embodiment of the present disclosure. The screen display 1150 includes a directory search box 1110, into which the agent can type all or a portion of an SME's name, with which to search the directory, and also a subject matter search box, into which the agent can type part or all of an SME's area of subject matter expertise, with which to search the directory. The screen display 1100 also includes a list of SMEs 1130 and the current status 1140 of each SME. Such status may for example be “Available”, “Busy”, “In Call”, “Unavailable”, “Away”, “Do Not Disturb”, “Offline”, “Meeting”, “Out Of Office”, etc.

However, unlike the screen display 1100, the novel screen display 1150 also includes an estimated time to availability (ETA) 1160 (e.g., in seconds, minutes, hours, or days) for each SME that comes up in the directory search, whose current status 1140 is anything other than “available”. For example, if the SME's current status is “In Call”, then the presence prediction system may return an ETA 1160 based on the time the call started as well as the typical duration of calls for that SME (typically a few minutes). Similarly, if the SME's current status is “Out of Office” (OOO), then the presence prediction system may return an ETA 1160 based on the time the OOO status began, as well as the typical duration of an OOO status for that SME (typically at least the remainder of the current day).

By integrating the inventive presence state predictor with the address book and presence server as disclosed herein, the presence prediction system allows the agent to see the additional data of the user's estimated time to availability, and thus to make intelligent choices regarding which SME to try to connect with to minimize agent efforts to obtain an SMEs answer or discussion.

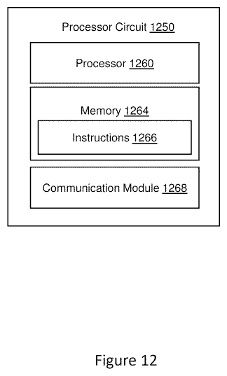

FIG. 12 is a schematic diagram of a processor circuit 1250, according to embodiments of the present disclosure. The processor circuit 1250 may be implemented in the system 100, the system 600, or other devices or workstations (e.g., third-party workstations, network routers, etc.), or on a cloud processor or other remote processing unit, as necessary to implement the method. As shown, the processor circuit 1250 may include a processor 1260, a memory 1264, and a communication module 1268. These elements may be in direct or indirect communication with each other, for example via one or more buses.

The processor 1260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1260 may also comprise another hardware device, a firmware device, or any combination thereof configured to perform the operations described herein. The processor 1260 may also be implemented as a combination of computing devices, e.g., a combination of a DSP and a microprocessor, a plurality of microprocessors, one or more microprocessors in conjunction with a DSP core, or any other such configuration.

The memory 1264 may include a cache memory (e.g., a cache memory of the processor 1260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1264 includes a non-transitory computer-readable medium. The memory 1264 may store instructions 1266. The instructions 1266 may include instructions that, when executed by the processor 1260, cause the processor 1260 to perform the operations described herein. Instructions 1266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1268 can include any electronic circuitry and/or logic circuitry to facilitate direct or indirect communication of data between the processor circuit 1250, and other processors or devices. In that regard, the communication module 1268 can be an input/output (I/O) device. In some instances, the communication module 1268 facilitates direct or indirect communication between various elements of the processor circuit 1250 and/or the system 100, 600, etc., The communication module 1268 may communicate within the processor circuit 1250 through numerous methods or protocols. Serial communication protocols may include but are not limited to United States Serial Protocol Interface (US SPI), Inter-Integrated Circuit (I²C), Recommended Standard 232 (RS-232), RS-485, Controller Arca Network (CAN), Ethernet, Acronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from the calendar 686 and/or presence server or UCaaS module 615) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the presence prediction system advantageously provides a practical benefit to UCaaS agents by permitting them to see when SMEs will next be available for consultation. Accordingly, it can be seen that the presence prediction system fills a long-standing need in the art, by enabling a agents to pick which SME(s) to wait for and which to ignore.

A number of variations are possible on the examples and embodiments described above. For example, an SME's status could include other values than those described herein. Depending on the implementation, the presence prediction engine could rely on custom machine learning models or on custom unweighted classical mathematical models. Other UCaaS and CCaaS applications and other hardware/system architectures may be employed than those described herein, while performing the same or similar functions. Tools such as Webhook, Kinesis, and Amazon Web Services are described herein for exemplary purposes only; equivalent or similar tools and services may be used instead or in addition. The technology described herein may be employed in any field where a first user needs to consult with a second user whose availability is inconstant but generally predictable.

Accordingly, the logical operations making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the presence prediction system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the presence prediction system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically identify wait times for a subject matter expert, the system comprising:
a cloud server having at least one processor and a non-transitory computer readable medium operably coupled thereto, the cloud server being in electronic communication with an agent computing device and a subject matter expert (SME) computing device, the processor comprising a presence aggregator module and a presence prediction system, the server being in electronic communication with a database for storing presence data associated with the SME computing device, the computer readable medium comprising a plurality of instructions stored in association therewith that are accessible to, and executable by, the processor, to perform operations which comprise:
over a first period of time, with the presence aggregator module:
receiving the presence data associated with the SME computing device;
storing the presence data in the database; and
with the stored presence data, training a custom machine learning network;
receiving an input from the agent computing device requesting contact with the SME computing device;
soliciting a status from the SME computing device;
if the status is not “Available”, then with the presence prediction system:
using the trained custom machine learning network, predicting a wait time after which the status will be “Available” and reporting the predicted wait time to the agent computing device; or
if the status is “Available”, then establishing a communication link between the agent computing device and the SME computing device and transmitting a query to the SME computing device.

2. The system of claim 1, wherein the custom machine learning network is a Long Short-Term Memory (LSTM) Recurrent Neural Network (RNN).

3. The system of claim 1, wherein the operations further comprise, with the agent computing device, displaying the predicted time to an agent.

4. The system of claim 1, wherein if the status is not “Available”, then the status is one of “Busy”, “In Call”, “Unavailable”, “Away”, “Do Not Disturb”, or “Offline”.

5. The system of claim 1, wherein the operations further comprise:
soliciting a calendar associated with the SME computing device; and
based on the calendar, refining the predicted time.

6. The system of claim 5, wherein the calendar contains, for each time in the calendar, a calendar status of “Available”, “Busy”, “Meeting”, or “Out Of Office”.

7. The system of claim 1, wherein the presence data comprises statuses of “Available”, “Busy”, “In Call”, “Unavailable”, “Away”, “Do Not Disturb”, or “Offline”, and one or more times associated therewith.

8. The system of claim 1, further comprising a communication link between the agent computing device and a patron computing device.

9. A computer-implemented method for automatically identifying wait times for a subject matter expert, the method which comprises:
with a cloud server having at least one processor and a non-transitory computer readable medium operably coupled thereto, the cloud server being in electronic communication with an agent computing device and a subject matter expert (SME) computing device, the processor comprising a presence aggregator module and a presence prediction system, the server being in electronic communication with a database for storing presence data associated with the SME computing device:
over a first period of time, with the presence aggregator module:
receiving the presence data associated with the SME computing device;
storing the presence data in the database; and
with the stored presence data, training a custom machine learning network;
receiving an input from the agent computing device requesting contact with the SME computing device;
soliciting a status from the SME computing device;
if the status is not “Available”, then with the presence prediction system:
using the trained custom machine learning network, predicting a wait time after which the status will be “Available” and reporting the predicted wait time to the agent computing device; or
if the status is “Available”, then establishing a communication link between the agent computing device and the SME computing device and transmitting a query to the SME computing device.

10. The method of claim 9, wherein the custom machine learning network is a Long Short-Term Memory (LSTM) Recurrent Neural Network (RNN).

11. The method of claim 9, further comprising, with the agent computing device, displaying the predicted time to an agent.

12. The method of claim 9, wherein if the status is not “Available”, then the status is one of “Busy”, “In Call”, “Unavailable”, “Away”, “Do Not Disturb”, or “Offline”.

13. The method of claim 9, further comprising:
soliciting a calendar associated with the SME computing device; and
based on the calendar, refining the predicted time.

14. The method of claim 13, wherein the calendar contains, for each time in the calendar, a calendar status of “Available”, “Busy”, “Meeting”, or “Out Of Office”.

15. The method of claim 9, wherein the presence data comprises statuses of “Available”, “Busy”, “In Call”, “Unavailable”, “Away”, “Do Not Disturb”, or “Offline”, and one or more times associated therewith.

16. The method of claim 9, further comprising establishing a communication link between the agent computing device and a patron computing device and transmitting a second query to the SME computing device.

17. A computer-implemented method, comprising:
over a first period of time:
receiving presence data associated with a subject matter expert (SME) via an SME computing device;
storing the presence data in a database; and
with the stored presence data, training a custom machine learning network;
receiving an input from an agent, via the agent computing device, requesting contact with the SME computing device;
soliciting a status from the SME computing device;
if the status is not “Available”, then:
using the trained custom machine learning network, predicting a wait time after which the status will be “Available” and reporting the predicted wait time to the agent via the agent computing device; or
if the status is “Available”, then establishing a communication link between the agent computing device and the SME computing device and transmitting a query to the SME via the SME computing device.

18. The method of claim 17, wherein if the status is not “Available”, then the status is one of “Busy”, “In Call”, “Unavailable”, “Away”, “Do Not Disturb”, or “Offline”.

19. The method of claim 17, further comprising:
soliciting a calendar associated with the SME computing device; and
based on the calendar, refining the predicted time.

20. The method of claim 19, wherein the calendar contains, for each time in the calendar, a calendar status of “Available”, “Busy”, “Meeting”, or “Out Of Office”.
